(19) United States
(12) Patent Application Publication
(10) Pub. No.: US 2008/0231570 A1
(43) Pub. Date: Sep. 25, 2008

(54) DISPLAY DEVICE

(75) Inventors: Hsu-Ming CHANG, Taipei (TW); Chun-Yin WU, Taipei (TW)

Correspondence Address: INGRASSIA FISHER & LORENZ, P.C., 7010 E. COCHISE ROAD, SCOTTSDALE, AZ, 85253, US

(73) Assignees: MILLI-HENRY ENTERPRISE CO., Taipei (TW); MILLI-HENRY TECHNOLOGY INC., Dong Guan (CN); WATERBEAR TECHNOLOGY CO. LTD., Taoyuan (TW)

(21) Appl. No.: 12/051,968

(22) Filed: Mar. 20, 2008

(30) Foreign Application Priority Data
Mar. 22, 2007 (TW) 96204646

(51) Int. Cl. G09G 3/34

(52) U.S. Cl. 345/84

(57) ABSTRACT

A display device includes a display module, a control module, and an elastic component. The display module includes a plurality of light emitting units. The control module is electrically connected to the display module, and the elastic component is connected to the display module. When the display module moves in response to an elastic movement of the elastic component, the control module controls the status of each light emitting unit so as to display a content information in a moving range of the light emitting units.

### CROSS REFERENCE TO RELATED APPLICATIONS

This application claims the right of priority based on Taiwan Patent Application No. 096204646 entitled “DISPLAY DEVICE”, filed on Mar. 22, 2007, which is incorporated herein by reference and assigned to the assignee herein.

### FIELD OF THE INVENTION

The present invention relates to a display device, and more particularly, to a display device for displaying content information in a moving range when a display module moves in response to an elastic movement of an elastic component.

### BACKGROUND OF THE INVENTION

Various light emitting diode (LED) based illumination products are widely utilized in daily lives, and LED glow sticks are generally applied in many occasions. For example, a traffic police may use a glow stick to instruct the drivers or pedestrians in a dim light climate or at night. The fans in a concert may wave with glow sticks in hand to show their passions. However, shaking or waving the glow sticks through the motion of hands or arms is easily subjected to tiresome, and the motion of the glow stick is usually not consistent and fast enough to display content information in a fixed moving range. When content information to be displayed by the glow stick gets complicated, a ghost image may occur in the moving range that is likely to obscure the meaning of the content information.

In addition, a conventional glow stick usually displays the content information to a viewer in front of the user, and the user may have difficulties to recognize the exact content information displayed by the glow stick simultaneously.

Consequently, a conventional display device, such as the glow stick, requires strenuous efforts to display desired content information.

### SUMMARY OF THE INVENTION

One aspect of the present invention is to provide a display device, which implements an elastic component to facilitate the movement of a display module so as to display content information in a moving range.

Another aspect of the present invention is to provide a display device with a light guide component so as to present the content information displayed by the display module to a user simultaneously.

The present invention provides a display device including a display module, a control module electrically connected to the display module, and an elastic component connected to the display module. The display module includes a plurality of light emitting units. The control module controls the status of each light emitting unit so as to display a content information in a moving range of the light emitting units when the display module moves in response to an elastic movement of the elastic component.

In another embodiment, the display device further includes a communication module, which is configured to communicate with an external device to receive or transmit control data. The control module controls the light emitting units according to the control data to display or update the content information

In a further embodiment, the display device further includes a storage unit for storing the control data and a power supply module for providing power to the display module and the control module. A light guide component is also provided to couple with the display module to present the content information to a user.

The foregoing and other features of the invention will be apparent from the following detailed description of embodiment of the invention.

### BRIEF DESCRIPTION OF THE DRAWINGS

The present invention is illustrated by way of example and not intended to be limited by the figures of the accompanying drawing, in which like notations indicate similar elements.

FIG. 1 illustrates a schematic view of a display device according to one embodiment of the present invention;

FIG. 2 illustrates a structural view of a display device according to one embodiment of the present invention;

FIG. 3A illustrates a structural view of a display device with a light guide component according to another embodiment of the present invention;

FIG. 3B illustrates an enlarged structural view of a display device with a light guide component according to another embodiment of the present invention; and

FIGS. 4A and 4B illustrate structural views of a display device according to a further embodiment of the present invention.

### DETAILED DESCRIPTION OF THE INVENTION

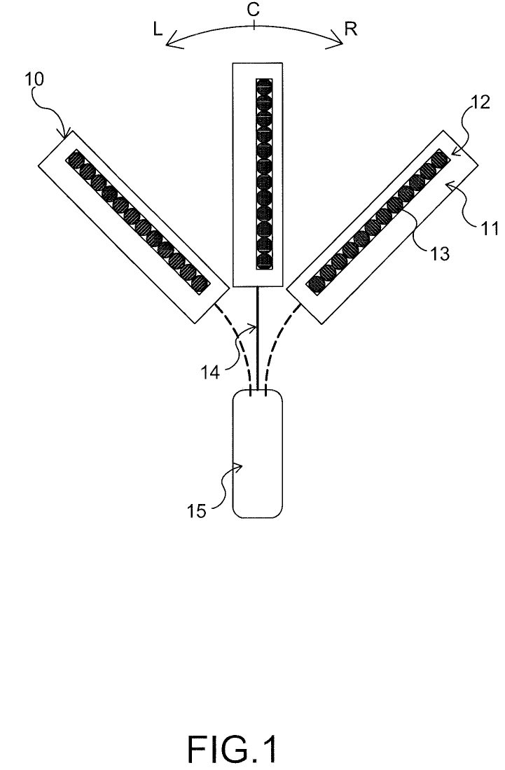

FIG. 1 illustrates a schematic view of a display device 10 according to one embodiment of the present invention. As shown in FIG. 1, the display device 10 includes a control module 11, a display module 12 with a plurality of light emitting units 13, an elastic component 14, and a power supply module 15. In this embodiment, the control module 11 and the display module 12 are connected to the power supply module 15 through the elastic component 14 to form a stick-like display device 10. Alternatively, the control module 11 may be integrated with the power supply module 15 to serve as a grip, instead of being integrated with the display module 12 as shown in FIG. 1.

Referring to FIG. 1, the display device 10 displays content information through the control of the control module 11, which controls the status of each light emitting unit 13 (illuminating or darkening) according to control data of the content information as the light emitting units 13 move at a speed causing the effect of persistence of human vision. Therefore, viewers can recognize the content information displayed within the moving range of the light emitting units 13. The present invention utilizes one or more rows of light emitting units 13 to display the content information through the elastic movement of the elastic component 14. The operation of the display device 10 will be described below.

FIG. 1 illustrates a moving range of the display module 12 with the light emitting units 13. The moving range is illustrated with a left point L, a central point C, and a right point R. When the user holds the display device 10, such as the power supply module 15, with an external force to move or shake the display device 10, the external force is transferred to the elastic component 14 to generate reciprocal elastic movements, which cause the display module 12 to move within a moving range corresponding to the elastic movements. For example, in response to the elastic movement, the display module 12 may move back and forth from the left point L through the central C to the right point R without additional force imposed by the user until the elastic movement of the elastic component 14 corresponding to the external force is diminished. Then, the user may apply another external force to the display device 10, and the display module 12 will move in response to the elastic movement of the elastic component 14 for a period of time. In such an arrangement, the display module 12 of the display device 10 may move within a moving range to display the content information with less external force imposed by the user. That is, due to the reciprocal elastic movement of the elastic component 14, the display module 12 can move regularly at a speed causing the persistence of human vision so as to display the content information within the moving range by controlling the status of each light emitting unit 13 while moving.

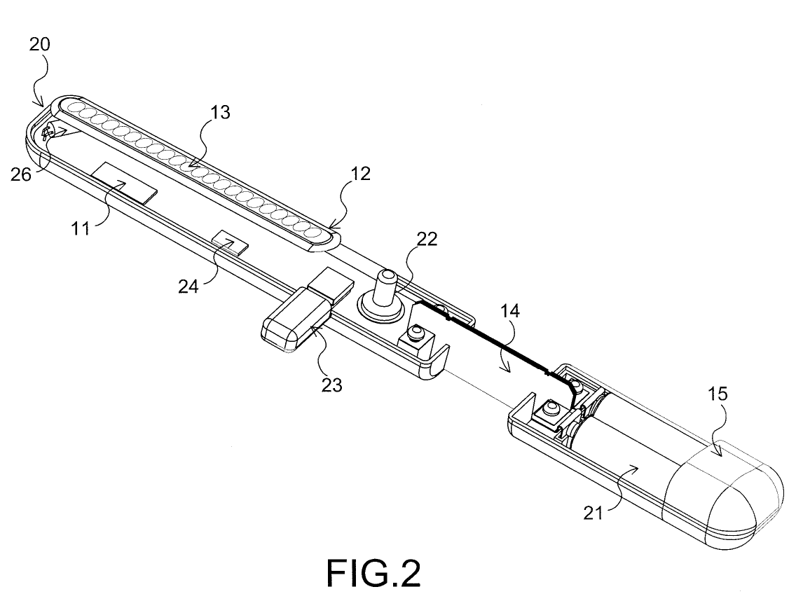

FIG. 2 illustrates a structural view of a display device 20 according to one embodiment of the present invention. The display device 20 includes a control module 11, a display module 12 with a plurality of light emitting units 13, an elastic component 14, a power supply module 15, a connecting unit 22, a communication module 23, a storage unit 24, and a direction detection module 26. The connecting unit 22 serves as a bridge of an upper casing and a lower casing of a housing. The power supply module 15 is configured to provide required power to the display device 10, such as the display module 12 and the control module 11. The power supply module may include a battery 21 or any suitable power supply. The direction detection module 26 is provided to detect a moving direction of the display device 20, such as the direction from left to right or from right to left, which is used to determine the display parameters for asymmetrical content information so that a viewer standing in front of the display device 20 (or the user) can see a correct displayed image, instead of a reversed image corresponding to the content information. The direction detection module 26 may be a ball switch, a mercury switch or a direction detection chip. Please note that when the content information to be displayed is symmetrical, such as heart pattern or smiling face [symbol] , the direction detection module is not necessary.

The communication module 23 is provided to communicate with an external device for transmitting or receiving the control data of the content information. For example, the communication module 23 may communicate with the external device to receive the control data of the content information, and the control data is then stored in the storage unit 24 of the display device 20. The communication module 23 may utilize a universal serial bus (USB), a RS232 interface, a universal asynchronous receiver/transmitter (UART) or Inter-Integrated-Circuit (12C) to communicate with the external device. Alternatively, the communication module 23 may communicate with the external device wirelessly by an infrared ray, a blue tooth, or a wireless network. The external device may be, but not limited to, a desktop computer, a notebook, a MAC computer or a PDA. Similarly, the control data may be downloaded from the display device 20 to the external device. For example, the control data may include information associated with the content information and control parameters of the display device 20.

In one embodiment, the control data is transmitted from the external device (not shown) to the display device 20 via the communication module 23 and stored in the storage unit 24. The storage unit 24 stores the control data associated with the content information or additional information. The storage unit 24 may be an EEPROM, a Flash ROM, or a memory chip, etc. The control module 11 controls the status of each light emitting unit 13 (such as illuminating or darkening) based on the control data so as to display the content information within a moving range of the light emitting units 13 while the light emitting units move in response to the elastic movement of the elastic component 14. The light emitting units 13 may include multiple light emitting diodes (LEDs), organic light emitting diodes (OLEDs), or lamps, arranged in array or arbitrarily. For example, the light emitting diodes 13 are arranged in a line perpendicular to the moving direction of the elastic component 14.

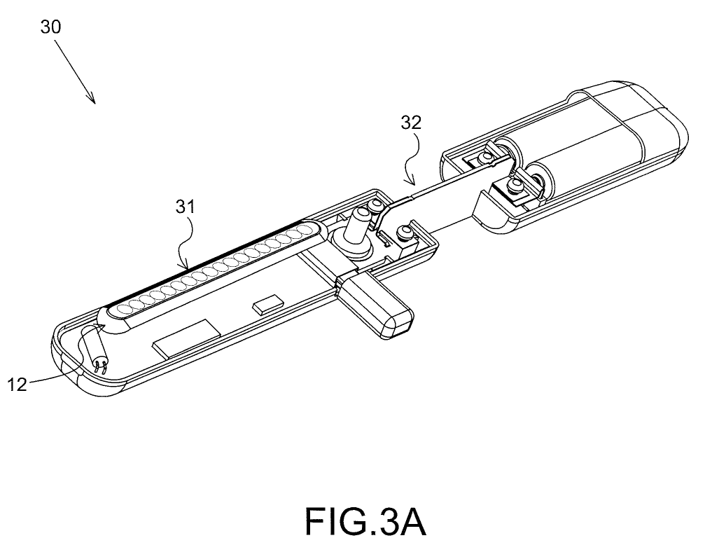

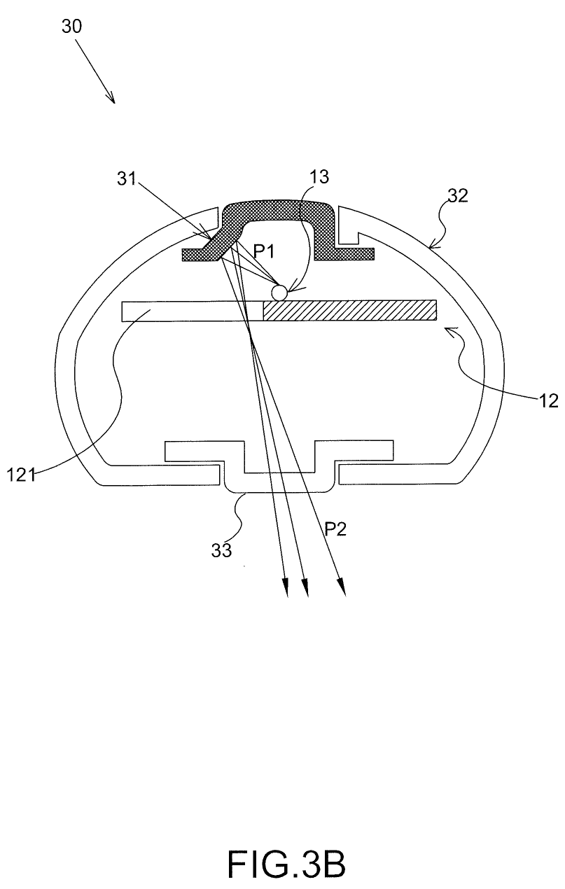

The present invention utilizes the elastic component 14 to cause the display module 12 to move in response to the elastic movement of the elastic component 14 so that the display device 20 can display the content information in the moving range of the display module 12 with less force applied by the user. The elastic component 14 may be a leaf spring, a coil spring, or a torsion spring, but not limited thereto. The elastic component 14 may include more than one leaf spring or coil spring, such as two leaf springs 32 (as shown in FIG. 3A). In addition, the two leaf springs 32 may be used as two conductive lines respectively connected to the positive electrode and the negative electrode of the power supply module 15 to provide power to the control module 11 and the display module 12. Alternatively, when the coil spring is used, the power cable of the power supply module 15 may pass through the central hollow part of the coil spring to provide power to the control module 11 and the display module 12 so that the exterior appearance of the display device 20 can be enhanced.

Furthermore, the elastic movement of the elastic component 14 is not limited to the right to left direction or the front to rear direction. In another embodiment, the elastic component 14 may move at any suitable direction or multiple directions according to different design needs.

FIG. 3A illustrates a structural view of a display device 30 with a light guide component 31 according to another embodiment of the present invention. In this embodiment, most components are similar to those of the display device 20 in FIG. 2. The display device 30 further includes the light guide component 31, which is connected to the display module 12 to present the content information to the user.

For example, in FIG. 3A, the light guide component 31 includes a mirror, a metal sheet, an aluminum foil, or a reflective material. In addition, the light guide component 31 and the display module 12 are arranged with an angle therebetween for clearly reflecting the content information to the user through a viewing window. The viewing window may be an opening or a transparent portion of the housing. The light guide component 31 is disposed to simultaneously present the content information to the user of the display device 30 by reflecting lights emitted from the light emitting units 13. In an exemplary embodiment, the light guide component 31 and the display module 12 are arranged with an angle of 45-degree therebetween to present reversed content information to the user so that the user can be aware of the content information displayed.

FIG. 3B illustrates an enlarged structural view of the light guide component 31 of the display device 30 according to one embodiment of the present invention. The display device 30 includes a display module 12 with a plurality of light emitting units 13, the light guide component 31, and a housing 32 with a viewing window 33. The display module 12 is designed with a transparent portion 121 or an opening, and the light guide component 31 is disposed to correspond to the light emitting units 13. In such an arrangement, the light guide component 31 is capable of reflecting the lights emitted from the light emitting units 13 through the transparent portion 121 to the viewing window 33, such as the light path P1 to P2. Therefore, the user can recognize the content information through the viewing window 33 by identifying the lighting status of the light emitting units 13.

As shown in FIG. 3B, the housing 32 covers at least a portion of the light emitting units 13 and the light guide component 31. The material of the housing 32 may include an opaque material, a translucent material, or a transparent material. The housing 32 is provided with the viewing window 33, and the light guide component 31 is provided corresponding to the viewing window 33 to reflect lights emitted from the light emitting units 13 and present the content information to the user.

FIG. 3B also illustrates the reflected light path (P1 to P2) for reflecting the status of each light emitting unit 13 to the viewing windows 33 by the light guide component 31. As a result, the user of the display device 30 may act on a real time manner to confirm that the displayed image is a correct image of the content information to be displayed.

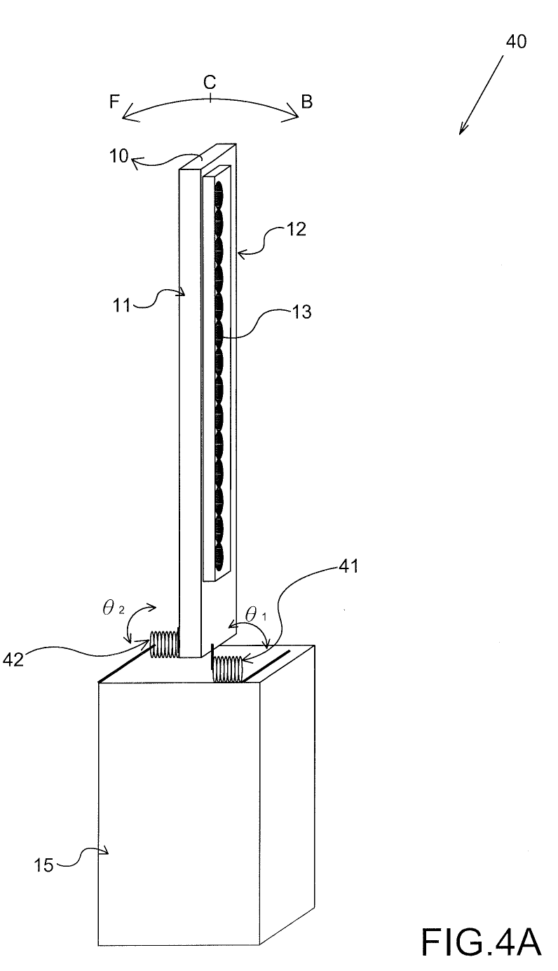

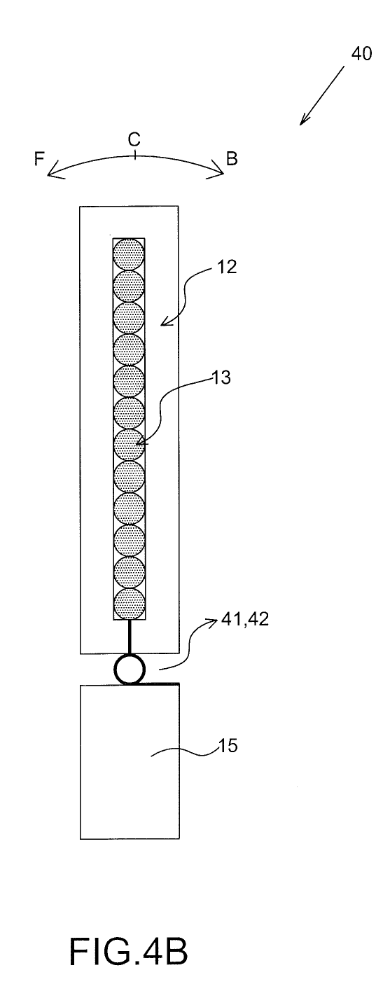

FIGS. 4A and 4B illustrate structural views of a display device 40 according to another embodiment of the present invention. In this embodiment, the elastic component includes two torsion springs 41 and 42, and other components are similar to those illustrated in FIG. 1.

As shown in FIGS. 4A and 4B, a moving range is illustrated with a front point F, a central point C, and a rear point B. When the user holds the display device 40, such as the power supply module 15, with an external force to move or shake the display device 40, the external force is transferred to the torsion springs 41 and 42 to cause the display module 12 to move. In this embodiment, the torsion spring 41 is disposed with an angle θ 1 between the display module 12 and the power supply module 15, and the torsion spring 42 is disposed with an angleθ 2 between the display module 12 and the power supply module 15. As the angleθ 1 or θ 2 is less than 90 degree, the torsion spring 41 or 42 is defined as compressed. As the angleθ 1 or θ 2 is more than 90 degree, the torsion spring 41 or 42 is defined as stretched. When the display module 12 moves from the central point C to the rear point B, the torsion spring 41 is compressed in response to the external force, while the torsion spring 42 is stretched to induce a reverse force corresponding to the external force. Then, the torsion spring 41 is stretched in response to the reverse force, and the torsion spring 42 is compressed 41 such that the display module 12 moves back and forth from the rear point R to the front point F. In such an arrangement, the display module 12 moves within the moving range from point R to point F without additional force imposed by the user until the elastic movement of the torsion sprigs 41, 42 corresponding to the external force is diminished. Then, the user may apply another external force to the display device 40, and the display module 12 will move in response to the elastic movement of the torsion springs 41, 42 for a period of time. Accordingly, the display module 12 of the display device 40 may move within a moving range to display the content information with less external force imposed by the user. Moreover, with the feature of the elastic component 14, the movement of the display module 12 may be facilitated to increase the speed or the moving range of the display module 12 compared with a conventional display device. That is, due to the reciprocal elastic movement of the torsion springs 41, 42, the display module 12 can move more easily and regularly at a speed causing the persistence of human vision so as to display the content information within the moving range.

Though only two torsion springs are illustrated in FIG. 4A, it will be appreciated that the number of the torsion springs is only an example for illustrating the present invention. The present invention may be implemented with one or more torsion springs in another embodiment.

In comparison with prior art, the present invention utilizing the elastic movement of the elastic component to display the content information in the moving range benefits the user by imposing less force. Furthermore, the light guide component reflecting the content information to the user allows the user to verify the content information being displayed in a real time manner.

While this invention has been described with reference to the illustrative embodiments, these descriptions should not be construed as a limit. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

What is claimed is:

1. A display device, comprising:
a display module including a plurality of light emitting units;
a control module electrically connected to the display module; and
an elastic component connected to the display module;
wherein the control module controls the status of each light emitting unit so as to display a content information in a moving range of the light emitting units when the display module moves in response to an elastic movement of the elastic component.

2. The display device of claim 1, wherein the light emitting units include multiple light emitting diodes (LEDs), organic light emitting diodes (OLEDs), or lamps arranged in array or arbitrarily.

3. The display device of claim 1, further comprising:
a communication module, communicating with an external device, configured to transmit or receive a control data, wherein the control module controls the light emitting units according to the control data to display or update the content information.

4. The display device of claim 3, further comprising a storage unit for storing the control data.

5. The display device of claim 3, wherein the communication module communicates with the external device by means selected from the group consisting of a USB, a UART, an 12C, and a combination thereof.

6. The display device of claim 3, wherein the communication module communicates with the external device through an infrared ray, a blue tooth, or a wireless network.

7. The display device of claim 1, wherein the elastic component is consisted of a leaf spring, a coil spring, or a torsion spring.

8. The display device of claim 1, further comprising a power supply module for providing a power for the display module and the control module.

9. The display device of claim 8, wherein the power supply module provides the power for the display module and the control module through the elastic component.

10. The display device of claim 1, further comprising a light guide component connected to the display module to present the content information to a user.

11. The display device of claim 10, wherein the light guide component and the display module are arranged with an angle therebetween.

12. The display device of claim 11, wherein the light guide component and the display module is arranged with an angle of 45-degree therebetween.

13. The display device of claim 10, wherein the light guide component comprises a material for reflecting lights emitted from the light emitting units.

14. The display device of claim 1, wherein the elastic movement of the elastic component moves in multiple directions.

15. The display device of claim 14, wherein the elastic movement of the elastic component moves in a direction back and forth along left to right or along front to rear.

16. The display device of claim 1, further comprising a housing for covering at least a portion of the display module.

17. The display device of claim 16, wherein the housing is made of an opaque material, translucent material, or a transparent material.

18. The display device of claim 16, wherein the housing is provided with a viewing window, and a light guide component is provided corresponding to the viewing window to reflect lights emitted from the light emitting units and present the content information to a user.
